(19) United States
(12) Patent Application Publication
(10) Pub. No.: US 2003/0051129 A1
(43) Pub. Date: Mar. 13, 2003

(54) Protecting confidential digital information at application service providers

(76) Inventors: Ravi Razdan, Solana Beach, CA (US); Jonathan Peter Huanes, San Diego, CA (US)

Correspondence Address: STREAMTONE, INC, 2683 VIA DE LA VALLE, G-427, DELMAR, CA, 92014, US

(21) Appl. No.: 09/948,536

(22) Filed: Sep. 10, 2001

(51) Int. Cl. H04L 9/00

(52) U.S. Cl. 713/151

(57) ABSTRACT

A method is described that allows data owned by a user to be stored in a secure manner at a third party site or service provider such that the third party is unable to read or use that data. Further, the user's data is made available to the user from any machine and location by holding the keys necessary for the encryption and decryption of the data at a designated keyholder location that the user has access to.

### FILED OF INVENTION

This invention relates to web services, specifically protection of customer confidential data from service provider or any third party.

### BACKGROUND OF THE INVENTION

Software is moving from packaged applications to services, commonly know as web services. Entities providing these services are called application service providers. This web service approach to IT and software provides cost savings and tremendous flexibility to customers. The major shortcoming hampering the adoption of web services is the lack of security of data such as memos, contact info, schedules, financial reports etc. stored on the ASP site as clear text. As such it is unsafe from a unscrupulous employee or a hacker. Also the need to access this information from multiple locations, multiple devices and by multiple people in an organization creates a situation which cannot be solved by existing security mechanisms.

Hence the current invention describes a general purpose mechanism to prevent ASPs, hackers or anybody with access to customer data to see it modify it and hence profit from it. In addition it also describes a mechanism to allow users to access the encrypted application data from any location, with any devices, either temporarily or permanently. Also a mechanism of defining levels of access to data based on organization roles is described. All this is achieved by using a dynamic key management protocol which solves the security issues preventing the adoption of web services.

### BRIEF SUMMARY OF INVENTION

A method of protecting digital information stored at a third party by ensuring that the keys that protect that data are held by an entity (key holder) other than the party holding the data. The key holder is responsible for providing access to authenticated clients by supplying them with the necessary keys to decode the stored data. The key holder provides keys via a security service which after client authentication dynamically loads the keys in the client with a explicit time out periods in case the client forgets to clear key from client device/software cache.

During a session with a server providing a web service, input data fields marked secure gets encrypted before transportation to server for storage. Correspondingly all data coming from the service with encrypted portion gets decrypted on the fly via the key resident on the client device/software. Certain non-critical portions of the application data might be in plain text. This is above and beyond any transport level protocol such as SSL being used to secure the communication channel.

The encryption/decryption keys are downloaded to the client device from the key holder either during a network log on process or are stored permanently for a secured device in a home or office. For a temporary access device such as a third party client device, a time out process happens after which the the keys need to be loaded again by reauthentication with the key holder.

The encryption/decryption is transparent to the user after the initial step of downloading the keys after authentication to the client devices and then clearing the key from the client.

In the case of multiple users for a service with different access levels, multiple keys are used. A client could use multiple keys for multiple pieces of data (one key per datum) in the encryption/decryption process based on the user profile of that client.

Further objects and advantages of my invention will become apparent from a consideration of the drawings and ensuing description.

### BRIEF DESCRIPTION OF THE SEVERAL VIEWS OF THE DRAWING

FIG. 1—the system architecture

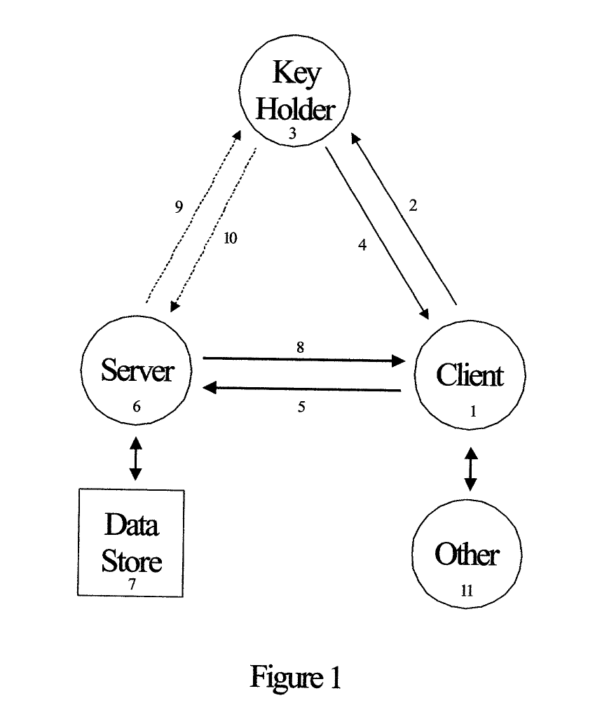

### DETAILED DESCRIPTION OF THE INVENTION

This embodiment of the invention is used to protect data stored at a third party from unauthorized access and which is displayed to clients using the HTTP and HTML/XML protocols.

The HTML/XML protocol is extended to include an additional tag that indicates the data contained by that tag is encrypted when stored at the third party. The tag also includes an attribute indicating the level of access that is required to decode that tag and a key identifier so that multiple pieces of data requiring different keys for decryption can be placed on the same HTML/XML page.

Defined access levels are CLEAR for clear text; SERVICE for data that the third party is permitted to decode on an as needed basis, for example to provide search functionality; TEMPORAL for data access that is granted on a temporal basis; TRUSTED for data access that is granted until it is explicitly revoked.

Some HTML tags themselves contain data (for example the INPUT tag allows an initial setting of the VALUE attribute) and to allow for this additional attributes have been added to such tags that allows the requirement of encryption and the setting of the security level.

Data contained within this tag is always stored at the third party (6) encoded (7) and only decoded by the client (1) (unless either of the access levels CLEAR or SERVICE are indicated).

Data (8) displayed to the client (1) by the server (6) is decoded through the use of a key obtained in a secure manner (2,4) from the key holder (3), for example via SSL. The client display software (browser) (1) is configured by the end user to indicate whether it is trusted or not (for example to distinguish between the user's personal machine and one which has shared access). A browser (1) that is not marked as trusted is only given temporal access (in other words the keys supplied are only valid for a certain length of time after which the user must re-authenticate thenselves before the keys can be re-acquired from the key holder (3)).

Data (8) that has received by the client may be sent in either encrypted or clear form to another third party (11) for additional processing. In the event that the data is sent encrypted, the independent third party must acquire the keys from the key holder (3) using the mechanisms already described.

Keys held by the key holder (3) can be shared to allow a group of individuals to share access to the data stored at the third party without needing to use the same authenticator.

The browser (1) is also responsible for encoding any data that the user enters that is contained within the encryption tag using the keys obtained from the key holder (3) prior to its being sent (5) to the server (6).

Service providers (6) are permitted to examine tagged data (7) that has access levels of either CLEAR or SERVICE. In the CLEAR case no keys are required to examine the data. In the SERVICE case, the provider must authenticate themselves with the key holder over a secure channel (9,10) to obtain the necessary decoding key. Service providers are required not to cache or otherwise store decoded data outside of the operation being required by the user.

In the preferred embodiment users are provided with a mechanism that permits them to set the desired access level of the data (7) that they are storing at the third party (6). Browsers (1) that accept the encryption tag use a visual affordance to indicate what the assigned security level is on a tagged data field.

While my description contains many specificities, these should not be construed as limitations on the scope of the invention, but rather as an exemplification of one preferred embodiment thereof.

Accordingly, the scope of the invention should be determined not by the embodiment illustrated, but by the appended claims and their legal equivalents.

1. A method for protecting data resident at a third party service provider, from being viewed or altered by anyone without the author's consent, said method comprising:
having user data stored at a third party;
marking or tagging said data as protected;
having an enryption/decryption key(s) held by a key holder;
user's client software obtains said key(s) through an authentication mechanism;
user's client software obtains encrypted data from said third party;
user's client software uses the said decryption key to decode the said encrypted data;
user's client software uses the said encryption key to encode any protected data to be stored at said third party; and
user's client software sends said encrypted data to said third party for storage

2. The method in claim 1 wherein information with the protected data tag to indicate the desired security access

3. The method in claim 1 wherein multiple pieces of data are protected by multiple encryption/decryption keys on a one to one basis

4. The method in claim 1 wherein the client removes the encryption/decryption keys after some elapsed time period so that it can no longer perform the encryption/decryption operation

5. The method in claim 1 wherein the client removes the encryption/decryption keys in response to a specific user action so that it can no longer perform the encryption/decryption operation

6. The method in claim 1 wherein the client makes the data available in either an encrypted or clear text form to another third party for additional processing

7. The method in claim 1 wherein the user is able to specify which key is required and what the desired security access level is for a particular piece of data
